(19) United States
(12) Patent Application Publication
(10) Pub. No.: US 2014/0279450 A1
(43) Pub. Date: Sep. 18, 2014

(54) METHOD AND SYSTEM FOR A SECURE DIGITAL REPOSITORY FOR ALL CUSTOMER DOCUMENTS, WITH A DOCUMENT INHERITANCE FACILITY

(71) Applicant: Inder-Jeet Singh Gujral, Wenham, MA (US)

(72) Inventor: Inder-Jeet Singh Gujral, Wenham, MA (US)

(21) Appl. No.: 13/832,187

(22) Filed: Mar. 15, 2013

(51) Int. Cl. H04L 29/06; G06Q 30/04

(52) U.S. Cl. CPC H04L 67/42; G06Q 30/04
USPC 705/40; 709/219

(57) ABSTRACT

A system and method are disclosed for a secure digital repository for all of customer's documents in a secure, easily retrievable digital form. The system gathers documents in paper and electronic form from the customer and institutions with whom the customer is associated, reads the documents to create a calendar with automated reminders for the customer, and establishes an automated system to detect death and other significant events, and to disburse documents to persons inheriting them as directed by the customer.

### TECHNICAL FIELD

Embodiments of the present invention relate generally to the processing and storage of electronic documents, and more particularly to the collection and secure storage thereof in a centralized repository.

### BACKGROUND ART

Modern life has resulted in a tremendous proliferation of important personal documents. From deeds to houses and cars, to home and life insurance policies, from tax documents to the ever-burgeoning stack of medical records and bills, modern people are responsible for a host of pieces of paper, each of which could prove to be important for unpredictable reasons. Organizing these documents so that they are not lost, and so that their owner can readily retrieve them, is no easy matter. In many cases, the documents also contain various degrees of time-dependent material. Plans and contracts expire, interest rates rise, and bills come due, all as set forth in the various documents sitting forgotten in boxes and filing cabinets. This can be especially troublesome where the person most affected by a particular item is not its creator. For instance, it is all too possible to be the beneficiary of a life insurance plan or trust without being aware of its existence. The unpleasant aftermath of a loved-one's death often carries equal measures of grief and logistical irritation, as those left behind scramble to pay funeral costs and arrange the decedent's estate. In particular, numerous life-insurance companies are sitting on billions of dollars in unclaimed benefits simply because the survivors of the policyholder may have no idea that such a policy exists, and the insurance carrier has no particular reason to aggressively seek out the survivors.

Some innovative people have tried to solve the above problems by shifting to documents in electronic form, which are easier to preserve and duplicate. Unfortunately, many different companies have created their own systems of electronic documents separately, and so the problem of widely distributed important paper documents has largely been replaced by a similarly diffuse set of important electronic documents, difficult for their owners to collect. There are some products that allow a person to store electronic documents at a centralized location such as a web site, but such products still largely depend on the user to perform the leg-work to collect the document.

The electric age has also created new challenges with regard to the inheritance of documents. If a person dies (particularly unexpectedly), one of the consequences is that it is not always obvious what their assets are, and who should get them. As an example, assume that the person has an online bank or investment account. Presumably it has a login and password, both of which are in this person's head. If the person in question passes away without conveying this information to someone else, then there may be no practical way (without massively expensive and time-consuming forensics across multiple institutions) to even tell that they have this account, since there is no paper trail, nor any other record of its having existed. The same is true to a lesser extent for such things as email accounts, Facebook accounts and so on—others may know that these things exist, but there may be no easy way to get access to them, even for authorized people.

### SUMMARY OF THE EMBODIMENTS

It is therefore a goal of the present invention to create a centralized digital repository for all of a person's documents, which gathers those documents to itself at the customer's direction, and makes it easy to deposit future documents to the same repository for later use. It is a further purpose of the instant invention to store the documents securely, but in a manner permitting easy retrieval for persons authorized by the customer. It is still another goal of this invention to create a simple and effective way for people chosen by the customer to inherit electronic documents from the customer upon death, incapacity, or other events that make the inheritance necessary.

A method is disclosed for gathering a customer's documents in a central repository and making them available as needed. The method is performed by at least one electronic device having a processor and a memory and connected to a network, for managing customer documents, and involves receiving customer account data for a customer over the network, creating a customer account for that customer and obtaining third-party user account information over the network. The method next involves using that third-party user account information to request documents from other electronic devices connected to the network. The next step involves receiving customer documents in electronic form via the network, capturing paper documents optically using optical data entry means connected to the electronic device or devices and transforming those captured images into electronic documents, and maintaining the documents the devices' memory. Finally, the documents are published to a client device via the network as authorized by the customer.

In a related embodiment, the method also includes generating a report describing success or failure in obtaining the documents from third parties, maintaining that report in device memory, and publishing the report to a client device via the network as authorized by the customer. According to another embodiment, the devices receive paperless billing from third-party devices. Under another embodiment, the device or devices accept a search query and retrieve documents matching that query. In still another related embodiment, the method involves dividing each document up into sub-documents, encrypting each subdocument separately, storing each encrypted subdocument in memory, retrieving each encrypted subdocument from memory decrypting each encrypted subdocument, and reassembling the subdocuments to form the original document. Yet another embodiment involves extracting logistical information from the documents, creating a calendar using that logistical information, and publishing the calendar representation to a client device as authorized by the customer. An additional embodiment involves sending reminders to a client device authorized by the customer, as directed by the logistical information. Another related embodiment permits inheritance of documents by maintaining a list of document inheritors and at least one trigger event profile representing a trigger event in the memory of the device or devices, and contacting a person for confirmation of the trigger event upon encountering data matching the trigger event profile. Upon confirming occurrence of the trigger event, the embodiment involves sending documents to the document inheritors. In one more embodiment of the disclosed method, the system monitors third-party data for data matching that trigger event profile.

Also disclosed is a system for managing customer documents, including at least one server device linked by a network to at least one client device. The devices' processors are programmed to create an application made up of a Network Communication Component, a Processing Component, a Data Storage Component, and a Data Entry Component. The Network Communication Component is configured to receive customer account data for a customer and third-party user account information via the network, to request documents from other electronic devices coupled to the network using that third-party account data, to receive customer documents in electronic form via the network and to publish the documents to a client device via the network as authorized by the customer. The Processing Component is configured to create a customer account for the customer. The Data Storage Component is configured to maintain documents in the devices' memory. The Data Entry Component is configured to capture paper documents optically using optical data entry means coupled to the electronic device or devices and transforming the images thus created into electronic documents.

In a related embodiment, the Processing Component is configured to generate a report describing success or failure in obtaining documents from third-party electronic devices, the Data Storage Component is configured to maintain the report in memory, and the Network Communication Component is configured to publish the report to a client device via the network as authorized by the customer. According to another embodiment, the Network Communication Component is configured to receive paperless billing from third-party devices. Under an additional embodiment, the Network Communication Component is configured to accept a search query and the Data Storage Component is configured to retrieve documents matching that query. An additional embodiment involves the Processing Component dividing each document up into sub-documents, encrypting each subdocument separately, decrypting each encrypted subdocument, and reassembling said subdocuments to form the original document, and the Data Storage Component storing each encrypted subdocument in memory and retrieve each encrypted subdocument from memory. Yet another embodiment configures the Processing Component to extract logistical information from documents and create a calendar using that logistical information, and configures Network Communication Component to publish the calendar representation to a client device as authorized by the customer, via the network. A related embodiment configures the Network Communication Component to send reminders to a client device authorized by the customer, as directed by that logistical information. Still another embodiment accomplishes document inheritance by configuring the Data Storage Component to maintain a list of document inheritors and a trigger event profile representing a trigger event in the memory. The Network Communication Component is configured to contact a person for confirmation of the trigger event upon encountering data matching the trigger event profile and to send documents to the document inheritors upon confirming occurrence of the trigger event. Finally, one more system embodiment involves configuring the Network communication Component to monitor third-party data for data matching the trigger event profile.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flowchart showing some embodiments of the claimed method.

FIG. 2 is a schematic diagram illustrating a typical electronic device as described in this document.

FIG. 3 is a schematic diagram illustrating the basic structure of a web application platform and illustrating the claimed system.

### DETAILED DESCRIPTION OF SPECIFIC EMBODIMENTS

Definitions. As used in this description and the accompanying claims, the following terms shall have the meanings indicated, unless the context otherwise requires:

An “electronic device” is defined herein as including personal computers, laptops, tablets, smart phones, and any other electronic device capable of supporting an application as claimed herein.

A device or component is “coupled” to an electronic device if it is so related to that device that the product or means and the device may be operated together as one machine. In particular, a piece of electronic equipment is coupled to an electronic device if it is incorporated in the electronic device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” is a general term for all equipment coupled to an electronic device that may be used to enter data into that device. This definition includes, without limitation, keyboards, computer mouses, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “manual data entry means” is the set of all data entry devices coupled to the electronic device that permit the user to enter data into the electronic device using manual manipulation. Manual entry means include without limitation keyboards, keypads, touchscreens, track-pads, computer mouses, buttons, and other similar components.

An electronic device's “optical data entry means” is a component coupled to the electronic device that records images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other electronic devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

An electronic device's “display means” is a device coupled to the electronic device, by means of which the electronic device can display images. Display means include without limitation monitors, screens, television devices, and projectors.

To “maintain” data in the memory of an electronic device means to store that data in any memory coupled to the electronic device in a form convenient for retrieval as required by the algorithm at issue, and to retrieve, update, or delete the data as needed.

To “publish” a document or other electronically stored datum to a device means transmit any representation of any part of that datum to the device. For example, “publishing” a document to a client device could mean sending a representation of the entire document (e.g. in Portable Document Format), to the device, or it could mean sending a summary, an excerpt, a description of the document or any part of it, or basic data such as the name, type, and relevant dates of the document.

The system and method disclosed herein will be better understood in light of the following observations concerning the electronic devices that support the disclosed application, and concerning the nature of applications in general. An exemplary electronic device is illustrated by FIG. 2. The processor 200 may be a special purpose or a general purpose processor device. As will be appreciated by persons skilled in the relevant art, the processor device 200 may also be a single processor in a multi-core/multiprocessor system, such system operating alone, or in a cluster of computing devices operating in a cluster or server farm. The processor 200 is connected to a communication infrastructure 201, for example, a bus, message queue, network, or multi-core message-passing scheme.

The electronic device also includes a main memory 202, such as random access memory (RAM), and may also include a secondary memory 203. Secondary memory 203 may include, for example, a hard disk drive 204, a removable storage drive or interface 205, connected to a removable storage unit 206, or other similar means. As will be appreciated by persons skilled in the relevant art, a removable storage unit 206 includes a computer usable storage medium having stored therein computer software and/or data. Examples of additional means creating secondary memory 203 may include a program cartridge and cartridge interface (such as that found in video game devices), a removable memory chip (such as an EPROM, or PROM) and associated socket, and other removable storage units 206 and interfaces 205 which allow software and data to be transferred from the removable storage unit 206 to the computer system.

The electronic device may also include a communications interface 207. The communications interface 207 allows software and data to be transferred between the electronic device and external devices. The communications interface 207 may include a modem, a network interface (such as an Ethernet card), a communications port, a PCMCIA slot and card, or other means to couple the electronic device to external devices. Software and data transferred via the communications interface 207 may be in the form of signals, which may be electronic, electromagnetic, optical, or other signals capable of being received by the communications interface 207. These signals may be provided to the communications interface 207 via wire or cable, fiber optics, a phone line, a cellular phone link, and radio frequency link or other communications channels. The communications interface in the system embodiments discussed herein facilitates the coupling of the electronic device with data entry devices 208, which can include such manual entry means 209 as keyboards, touchscreens, mouses, and trackpads, and optical data entry means 214 such as scanners or digital cameras, the device's display 210, and network connections, whether wired or wireless 213. It should be noted that each of these means may be embedded in the device itself, attached via a port, or tethered using a wireless technology such as BLUETOOTH®.

Computer programs (also called computer control logic) are stored in main memory 202 and/or secondary memory 203. Computer programs may also be received via the communications interface 207. Such computer programs, when executed, enable the processor device 200 to implement the system embodiments discussed below. Accordingly, such computer programs represent controllers of the system. Where embodiments are implemented using software, the software may be stored in a computer program product and loaded into the electronic device using a removable storage drive or interface 205, a hard disk drive 204, or a communications interface 207.

Persons skilled in the relevant art will also be aware that while any device must necessarily comprise facilities to perform the functions of a processor 200, a communication infrastructure 201, at least a main memory 202, and usually a communications interface 207, not all devices will necessarily house these facilities separately. For instance, in some forms of electronic devices as defined above, processing 200 and memory 202 could be distributed through the same hardware device, as in a neural net, and thus the communications infrastructure 201 could be a property of the configuration of that particular hardware device. Many devices do practice a physical division of tasks as set forth above, however, and practitioners skilled in the art will understand the conceptual separation of tasks as applicable even where physical components are merged.

This invention is deployed as a web application. Persons of ordinary skill in the art will recognize a web application as a particular kind of computer program system designed to function across a network, such as the Internet. A schematic illustration of a web application platform is provided in FIG. 3. Web application platforms typically include at least one client device 300, which is an electronic device as described above. The client device 300 connects via some form of network connection to a network 301, such as the Internet. Also connected to the network 301 is at least one server device 302, which is also an electronic device as described above. Of course, practitioners of ordinary skill in the relevant art will recognize that a web application can, and typically does, run on several server devices 302 and a vast and continuously changing population of client devices 300. Computer programs on both the client device 300 and the server device 302 configure both devices to perform the functions required of the web application 304. Web applications 304 can be designed so that the bulk of their processing tasks are accomplished by the server device 302, as configured to perform those tasks by its web application program, or alternatively by the client device 300. However, the web application must inherently involve some programming on each device.

Many electronic devices, as defined herein, come equipped with a specialized program, known as a web browser, which enables them to act as a client device 300 at least for the purposes of receiving and displaying data output by the server device 302 without any additional programming. Web browsers can also act as a platform to run so much of a web application as is being performed by the client device 300, and it is a common practice to write the portion of a web application calculated to run on the client device 300 to be operated entirely by a web browser. Such browser-executed programs are referred to herein as “client-side programs,” and frequently are loaded onto the browser from the server 302 at the same time as the other content the server 302 sends to the browser. However, it is also possible to write programs that do not run on web browsers but still cause an electronic device to operate as a web application client 300. Thus, as a general matter, web applications require some computer program configuration both of the client device (or devices) 300 and the server device 302 (or devices). The computer program that comprises the web application component on either electronic device's system FIG. 2 configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Finally, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

FIG. 1 illustrates the disclosed method for storing and retrieving personal documents. The method is performed by one or more servers connected to a network, such as the Internet, which in turn is connected to client machines used by customers or people to whom customers have granted access. Upon receiving customer data 100, the system creates a customer account 101. This process may be initiated by the customer, but a third party, such as a bank or other institution involved with the customer, could create the account 101 on the customer's behalf, with the customer's permission. This means that the administrator of the system can also create partnership programs with institutions that tend to generate customer documents; the institutions can maintain files for their customers that contain documents in the custody of the institutions, and offer the customers the option of creating a more general repository with the institutions' documents as a nucleus. The creation of the customer account 101 should ideally also include the establishment of a security system by means of which only the customer, and persons the customer authorizes, may gain access to any of the customer's account information or documents.

Once the customer account exists, the system proceeds to collect the customer's personal documents. This is ultimately a customer-directed process: the personal documents can include virtually any document the customer wishes to have at his or her disposal in electronic form, including without limitation contracts, deeds, wills, bills, trusts, medical records, and anything else of a legal, financial, or personal nature the customer chooses, within the bounds of applicable law. The system acquires these documents in several ways. First, it can have the documents sent in electronic form 104 via the network. Protocols for sending documents over networks are well-known to persons skilled in the art; among other options, documents can be sent via File Transfer Protocol (FTP) or via electronic mail. The customer can send any electronically stored documents in the customer's possession over the network. The customer can also give the system third-party account information 102 necessary to access the customer's accounts on other devices connected to the network, such as devices under control of another party with whom the customer has an account, from which the system can request electronic transmission of customer documents 103. Customers can also set up regular forwarding from their own email accounts to the system, so that their emails are all captured as documents, along with attachments. Whatever the origin of the electronically transmitted documents, the system should ideally record each document's source in as much detail as possible. Of course, if one customer wants to send a document to another customer within the system, the exchange of documents is simply a matter of copying or even adding a link to the same document copy, and keeping track of document origin will be a simple matter of transaction history. The customer or the entity managing the system can also directly contact such providers by other means, such as telephone, electronic mail, or regular mail, to request that the documents be transmitted. The system can also receive documents in paper form, and scan them to create digital images 105, which can be converted to electronic documents by the system. Scanners and other optical data entry means capable of capturing such digital images are well-known to persons of ordinary skill in the art. As before, customer could send the paper documents directly, or request that another entity send them.

Once the system receives the documents, it maintains them in its memory 106. This can involve storing the documents in a directory on the servers, or in a database, or in any form of computer-readable storage coupled to the servers. As noted above, maintaining the documents implies not only storing them in and retrieving them from memory as needed, but also updating them, deleting them if necessary, and organizing them to aid in easy retrieval and viewing. Ideally, the customer can exercise some control over the way in which document storage is organized, so that the customer can sort through and find the documents easily. The customer should also be permitted to delete the documents when he or she chooses. Finally the documents are published 107 as directed by the customer. The customer should typically be able to see any document on the system, so the document chosen by the customer can be shown to him or her in full by transmitting image data to the customer's current client machine, or allowing the customer to download a copy of any document. Publication 107 also involves presenting titles, nicknames, excerpts, or summaries of documents for the customer's perusal, to aid the customer in locating documents he or she wishes to view in full. Finally, documents or any data from them may be published 107 to other persons or entities as directed by the customer. For instance, the customer can grant certain health care professionals the right to view certain medical documents, or can allow an attorney to view documents pertinent to the attorney's representation of the customer.

The instant invention may also be deployed as a system FIG. 3. The system includes at least one client device 300 and one server device 302. The two devices are connected by a network 301. Computer programs on the server devices 302 and client devices 300 combine to create an application 304, which may be run entirely on the server side or partially on the client side. The application is best understood by dividing it conceptually into components that perform the different categories of tasks necessary for the application to practice the disclosed invention. The first is a Network Communication Component 307, which controls communication between the servers 302 and client devices 300. The Network Communication Component 307 receives customer account data from a customer or other entity, for the purposes of creating a customer account. The Network Communication Component 307 is also designed to obtain third-party user account information as described above, and to request documents stored in an electronic form such as a PDF. The Network Communication Component 307 receives electronic documents over the network to store in the system. Finally, the Network Communication Component 307 publishes collected documents to client devices 300, by sending representations of those documents to client devices 300 for display via the client devices' displays 303. Another component of the application 304 is a Processing Component 305, which creates a customer account for the customer, a Data Storage Component 306, which maintains the documents in memory coupled to the servers 302, and a Data Entry Component 308 for capturing paper documents optically using optical data entry means 310 coupled to said electronic device or devices and transforming the images thus captured into electronic documents. The Processing Component 305, Network Communication Component 307, Data Entry Component 308, and Data Storage Component 306 need not be separate entities or modules within a particular program as implemented. The purpose of their status as elements in the system described in this document is to establish that the processor or processors of any electronic devices 300, 302 comprising the system must be configured to perform their functions as set forth, but not to dictate the architecture of a particular implementation.

Some of the document collection steps FIG. 1 described above, such as requesting third-party sites to send their documents 103, are not certain to succeed in every case, despite the best efforts of all parties. Many websites, with good reason, have security features designed to repel automated systems from accessing them; in some cases, laws and regulations might require some human interaction prior to the transfer of documents. The entity managing the system should be able to predict some of these situations, but it would still be useful for that entity, and the customer, to know when the automated transfer system has failed. For that reason, some embodiments of the method include the generation of a report detailing the success or failure of the document collection process 108. The report can be generated 108 during the collection procedure, or afterwards when the procedure has concluded, using data collected during the procedure. For example, when the system attempts to log onto the customer's bank account and download checking, savings, and credit card statements, if a security feature in the bank system denies the system access, that denial, and the reasons for it, can be recorded in the system's memory, and used to generate the report 108. Each such report is maintained in the system's memory 109 for future reference, and the report is published 110 to the client in some form or other. This helps the client follow up in collecting important documents that could otherwise fall through the cracks. The corresponding system embodiment FIG. 3 involves configuring the Processing Component 305 to generate the report, configuring the Data Storage Component 306 to maintain the report in the memory of the servers 302, and configuring the Network Communication Component 307 to publish the report to a client device via the network as authorized by the customer.

Paperless billing is an increasingly common phenomenon in the world of commerce. Paperless billing replaces bills, notices, and other documents traditionally sent by institutions via the postal service with digital versions of the same bills, notices, or documents. The digital versions are generally published by electronic mail, although other transfer protocols could be used. A customer of the disclosed method FIG. 1 would benefit from having such paperless billing documents collected in his or her account with the system. To save the customer the trouble of forwarding paperless billing, the system can set up a paperless billing account 111 with the institutions themselves. Where one of the institutions has created an account on the customer's behalf, this process will likely be a popular feature. The system can publish 107 the paperless billing documents to the customer as soon as they arrive; the only difference from traditional paperless billing will be the maintenance on the system of the electronic documents. Given the features the system offers for organization, security, and retrieval, however, this small difference could be very helpful for customers. The corresponding system embodiment FIG. 3 involves configuring the Network Communication Component 307 to receive paperless billing from third-party devices.

Convenient and reliable retrieval of the documents from storage is an essential part of the disclosed system. If the documents are organized in an intuitive manner, and particularly if the customer can direct their organization according to his or her preference, it should not be difficult for the customer to find them on the system. However, where there is a large volume of documents, or the customer cannot remember the source of a particular piece of information, the ability to search the documents 114 could be indispensable. In other words, a customer should be able to enter a query, and the system should retrieve documents matching the query 114. One way to accomplish this is to extract character data from the documents 112, and turn that character data into search keys 113. A search key is any item of data that can be used to identify a particular document; ideally it should represent information from the document that a customer is likely to search for. Thus, a good system of search keys will extract many keys per document, some of which are predictable fields likely to be common to all documents, such as titles and dates; others are strings excerpted from the document contents which together summarize the document's contents. The system matches the query entered by the customer to search keys 114 to locate a document for retrieval. According to the equivalent system embodiment FIG. 3, the Network Communication Component 307 is configured to accept a search query and the Data Storage Component 306 is configured to retrieve documents matching that query.

A central location containing the personal documents of large numbers of different people is a tempting target for identity thieves, so security will be essential in any implementation of the above method FIG. 1. Fortunately, the entity managing the system should be in a position to dedicate substantial resources to security. In addition to the various techniques for preventing breaches known to persons skilled in the art, some embodiments of the method include an algorithm to minimize the damage resultant from such breaches. When each document is stored in the system memory, 106, the system divides it into sections 115 or subdocuments. This division could involve merely separating the document into different blocks of text and images which would each be recognizable as part of a document, but it could also be done in such a way that each subdocument is not itself intelligible; for instance, if the document is initially stored as a long array of bits in the underlying electronic device, one subdocument could consist of every third bit from that array. Any approach can be used as long as the subdocuments can be reassembled to create the document again. After division, the system encrypts each subdocument separately 116 using a robust cryptosystem. Separate encryption in this section refers to using a different encryption key for each subdocument. A number of different techniques for encryption are known to persons skilled in the art, and the entity implementing the method can choose the most appropriate one for its needs. When the customer or other authorized person wishes to read or download a document, the various encrypted subdocuments are decrypted 117 and reassembled 118 prior to publication of the document 107. Any entity that attempts to steal documents by raiding the system memory through other channels will end up with many different encrypted files, each of which when decrypted is itself useless as a source of information. Even if the hacker in question has managed to download all of the subdocuments for any one of the documents on the system, the process of breaking the encryption on every file and then attempting to join them into intelligible documents can be made so onerous as to be prohibitive.

The Processing Component 305 in a related system embodiment FIG. 3 is disposed to separate documents into subdocuments as described above, and to encrypt the subdocuments separately. The Data Storage Component 306 stores the separately encrypted subdocuments in memory coupled to the servers 302. When the documents are retrieved for viewing by an authorized person, the Data Storage Component 306 retrieves the subdocuments that make up the document in question, and the Processing Component 305 decrypts them. Finally, the Processing Component 305 reassembles the subdocuments into a document, which is ready to be published as above.

In addition to providing customers with a place where they can reliably store their personal documents, some embodiments of the disclosed method FIG. 1 also help customers keep current with their obligations as set forth in those documents by means of an automatically generated calendar feature 120. For the purposes of this document, a “calendar” is a digitally stored data file or data structure whose elements represent events occurring in the past or future, and which can be published to a user of the system in such a way as to indicate when each event is occurring in time. The system creates the calendar by parsing the documents for logistical information 119. Logistical information is information concerning events that have to occur on particular dates, events that have to occur after a certain amount of time has elapsed, or any other information that places events or transactions described in the document in question at a particular place or time. A simple implementation could search for dates and times, and adjacent character data and save them in a data type that pairs dates with associated data. More complicated implementations could look for patterns that match time periods (e.g., numbers associated with character strings that indicate a unit of time, such as “years” or “days”). That time period could be linked with dates provided elsewhere on the document to produce an elapsed time period. One useful example of a document with logistical information is a bill: the logistical data is the payment due date, the amount of the payment due, and where and how the payment may be made. The logistical data thus collected is then saved in a calendar 120, which is any data type saved to the memory of the system that lists those pairs of dates with the associated event descriptions. The calendar is published 121 to client devices as authorized by the customer. Ideally, the customer will have the ability to compare the entries in the calendar to the documents with which they originated and to edit the entries as necessary to correct errors in the process, to render the entries in a form more readily recognizable to the customer, or to update information based on more recent events. In the equivalent system embodiment FIG. 3, the Processing Component 305 is configured to extract logistical information from documents as described above and assemble it into a calendar. The Network Communication Component 307 publishes the calendar representation to a client device as authorized by the customer.

In some embodiments of the method FIG. 1, the system uses the calendar to send reminder messages to the customer 122. These reminders may be transmitted by electronic mail, automatic phone calls, short message service messages to a mobile phone, or other transmittal. The messages could also be designed to pop up when the customer logs onto his or her account to view documents. The lead time for the message is another implementation decision; it could default to a certain period in days, weeks or hours. The customer could also choose what lead time reminders should provide, or choose not to have reminders at all under some circumstances. The equivalent system embodiment FIG. 3 involves configuring the Network Communication Component 307 to send reminders to a client device authorized by customer, following the direction of the logistical data. Preferably, the customer should be able to use manual entry means 309 to modify reminder settings.

Some embodiments of the claimed method FIG. 1 are calculated to solve the problem of document inheritance. To do so, the system maintains a list of document inheritors 123. This list in its simplest form could contain nothing more than a list of persons designated by the customer to inherit all documents maintained on the system for the customer's benefit. A preferred list also includes which documents or categories of documents to release to each person. In addition to accepting customer designations for the list, the system could also read the documents as before to extract the names of persons who should be inheritors. For instance, for a life insurance policy, the names of persons listed as beneficiaries on the policy documents could be put on the list and associated with the policy documents. The customer could then supply contact information and other details as needed, or add or remove inheritors. Also maintained in the system memory will be a set of event patterns 124 corresponding to an event after which the inheritors should ideally receive the documents. Upon the occurrence of data matching the event pattern 125, the system can send a confirmation message to the customer or to somebody else 126 to make sure the event has in fact occurred. Continuing the example of life insurance, one event that affects the beneficiaries' rights is the death of the insured. The event pattern 125 in that case could be a lack of contact from the customer for some period of time, suggesting, among other things, that the customer has died. However, there could be other explanations for the cessation of contact. The customer could be hospitalized or comatose, for example, or may have been incarcerated. Thus, the system could send an email 126 to one or more persons designated as contact persons, asking whether the customer is dead, and requiring an affirmative answer to confirm the event. Alternatively, the system could attempt to contact the customer directly 126, interpreting a failure to respond as confirmation. Whatever the implementation of the method fixes as confirming the event, when it is confirmed, the documents will be sent to the inheritors 127. Thus, for instance, if the insured in a life insurance policy has died, and this has been confirmed 126 by the next of kin, then the system will look up the beneficiaries on the inheritor list 123, and send the policy documents to them, so they know what they need to do to collect on the policy. Ideally, the list will also contain the inheritors' preferred means of contact and the information necessary to contact them by that means, such as their address, electronic mail address, phone number, or other information.

For the system FIG. 3 to accomplish the same inheritance process the Data Storage Component 306 must maintain a list of persons who will inherit the documents in the memory of the servers 302. A trigger event profile, describing a pattern of data matching the trigger event for the dissemination of the documents as set forth above, is also maintained in the servers' 302 memory by the Data Storage Component 306. The Network Communication Component 307 is configured according to this embodiment to send confirmation messages out to whatever person or entity has been selected as the contact for those messages, if data matching the trigger event profile is detected. Finally, if the event is confirmed for the purposes of the system, the Network Communication Component 307 sends the documents to the persons designated as inheritors. Note that in addition to sending the documents directly to devices or fax machines designated by the recipients, the Network Communication Component 307 could also send the documents to a printer so that they could be conveyed at the direction of the entity managing the system to the designated inheritors via the postal service or other carriers of parcels.

In addition to passively accepting data such as the passage of time or the arrival of a certain kind of document or message, under some embodiments of the method FIG. 1 the system can also monitor data on third-party sites to check for data matching the event pattern 128. For instance, if the event the system seeks to detect is the customer's death, the system could periodically check 128 the Social-Security Administration death master file. A listing of the customer's death on that file could be interpreted as matching the profile of a death event, triggering an attempt to contact another person or entity to confirm that death has occurred. The equivalent system embodiment involves configuring the Network communication Component 307 to monitor third-party data for data matching the trigger event profile.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method, performed by at least one electronic device having a processor and a memory and connected to a network, for managing customer documents, comprising:
receiving customer account data for a customer via said network;
creating a customer account for said customer;
obtaining third-party user account information via said network;
using said third-party user account information, requesting documents from other electronic devices coupled to said network;
receiving customer documents in electronic form via said network;
capturing paper documents optically using optical data entry means coupled to said electronic device or devices and transforming the digital images thus created into electronic documents;
maintaining said documents in said memory; and
publishing said documents to a client device via said network as authorized by said customer.

2. A method according to claim 1, further comprising:
generating a report describing success or failure in obtaining said documents from said other electronic devices;
maintaining said report in said memory; and
publishing said report to a client device via said network as authorized by said customer.

3. A method according to claim 1, further comprising:
receiving paperless billing from third-party devices;

4. A method according to claim 1, further comprising:
accepting a search query; and
retrieving documents matching said search query.

5. A method according to claim 1 wherein maintaining records in said memory comprises:
dividing each document up into sub-documents;
encrypting each subdocument separately;
storing each said encrypted subdocument in said memory;
retrieving each said encrypted subdocument from said memory;
decrypting each said encrypted subdocument; and
reassembling said subdocuments to form said document.

6. A method according to claim 1, further comprising:
extracting logistical information from said documents;
creating a calendar using said logistical information; and
publishing said calendar representation to a client device via said network as authorized by said customer.

7. A method according to claim 6, further comprising sending reminders to a client device via said network as authorized by said customer and as directed by said logistical information.

8. A method according to claim 1, further comprising:
maintaining in said memory a list of document inheritors;
maintaining in said memory a trigger event profile representing a trigger event;
contacting a person for confirmation of said trigger event upon encountering data matching said trigger event profile;
upon confirming occurrence of said trigger event, sending documents to said document inheritors.

9. A method according to claim 8 further comprising monitoring third-party data for data matching said trigger event profile.

10. A system for managing customer documents, comprising at least one server device linked by a network to at least one client device, each an electronic device having a memory and a processor, said processors together or singly operable to execute instructions to perform functions comprising:
a Network Communication Component, configured to:
receive customer account data for a customer via said network;
obtain third-party user account information via said network;
request documents from other electronic devices coupled to said network, using said third-party user account information;
receive customer documents in electronic form via said network; and
publish said documents to a client device via said network as authorized by said customer;
a Processing Component, configured to:
create a customer account for said customer;
a Data Storage Component, configured to:
maintain said documents in said memory; and
a Data Entry Component, configured to:
capture paper documents optically using optical data entry means coupled to said electronic device or devices and transforming the images thus created into electronic documents.

11. A system according to claim 10, wherein:
said Processing Component is configured to generate a report describing success or failure in obtaining said documents from said other electronic devices;
said Data Storage Component is configured to maintain said report in said memory; and
said Network Communication Component is configured to publish said report to a client device via said network as authorized by said customer.

12. A system according to claim 10, wherein said Network Communication Component is configured to receive paperless billing from third-party devices.

13. A system according to claim 10, wherein said Network Communication Component is configured to accept a search query and said Data Storage Component is configured to retrieve documents matching said search query.

14. A system according to claim 10, wherein
Said Processing Component is configured to:
divide each document up into sub-documents;
encrypt each said subdocument separately;
decrypt each said encrypted subdocument; and
reassemble said subdocuments to form said document; and
said Data Storage Component is configured to:
store each said encrypted subdocument in said memory; and
retrieve each encrypted subdocument from said memory.

15. A system according to claim 10 wherein said Processing Component is configured to extract logistical information from said documents and create a calendar using said logistical information, and said Network Communication Component is configured to publish said calendar representation to a client device via said network as authorized by said customer.

16. A system according to claim 15 wherein said Network Communication Component is configured to send reminders to a client device via said network as authorized by said customer, and as directed by said logistical information.

17. A system according to claim 10 wherein:
said Data Storage Component is configured to:
maintain in said memory a list of document inheritors; and
maintain in said memory a trigger event profile representing a trigger event; and
said Network Communication Component is configured to
contact a person for confirmation of said trigger event upon encountering data matching said trigger event profile; and
send documents to said document inheritors upon confirming occurrence of said trigger event.

18. A system according to claim 17 where said Network communication Component is further configured to monitor third-party data for data matching said trigger event profile.
